(19) United States
(12) Patent Application Publication
(10) Pub. No.: US 2015/0312491 A1
(43) Pub. Date: Oct. 29, 2015

(54) SOLID-STATE IMAGING DEVICE

(71) Applicant: Kabushiki Kaisha Toshiba, Minato-ku (JP)

(72) Inventor: Yoshitaka EGAWA, Yokohama (JP)

(73) Assignee: Kabushiki Kaisha Toshiba, Minato-ku (JP)

(21) Appl. No.: 14/628,637

(22) Filed: Feb. 23, 2015

(30) Foreign Application Priority Data
Apr. 24, 2014 (JP) 2014-090069

(51) Int. Cl. H04N 5/335; H04N 5/357; G06T 7/40; G06T 3/40; G06T 5/00; H04N 5/347; H04N 5/345

(52) U.S. Cl. CPC H04N 5/335; H04N 5/347; H04N 5/357; H04N 5/3458; G06T 3/4015; G06T 5/002; G06T 7/408; G06T 2207/20182; G06T 2207/10004; H04N 2101/00

(57) ABSTRACT

Provided is a solid-state imaging device which is capable of improving an image quality by changing a signal charge voltage conversion gain and performing a binning operation. According to one embodiment, a solid-state imaging device includes a pixel array unit including pixels that accumulate charges obtained by photoelectric conversion and are arranged in a row direction and a column direction in a form of a matrix and a switching transistor that is disposed between pixels and capable of changing a signal charge voltage conversion gain of a pixel and performing a binning operation.

### CROSS-REFERENCE TO RELATED APPLICATIONS

This application is based upon and claims the benefit of priority from Japanese Patent Application No. 2014-90069, filed on Apr. 24, 2014; the entire contents of which are incorporated herein by reference.

### FIELD

Embodiments described herein relate generally to a solid-state imaging device.

### BACKGROUND

In solid-state imaging devices, there are cases in which a binning operation is performed for the sake of high-speed reading and noise reduction. In the binning operation, there are cases in which a read pixel thinning operation, a signal charge adding operation, or the like is performed.

### BRIEF DESCRIPTION OF THE DRAWINGS

FIG. 1 is a block diagram illustrating a schematic configuration of a solid-state imaging device according to a first embodiment;

FIG. 2 is a circuit diagram illustrating an exemplary pixel configuration of 2×4 pixels in a 2-pixel 1-cell configuration of the solid-state imaging device of FIG. 1;

FIG. 3 is a timing chart illustrating voltage waveforms of the respective components when a pixel of FIG. 2 performs a first read operation;

FIG. 4 is a timing chart illustrating voltage waveforms of the respective components when the pixel of FIG. 2 performs a second read operation;

FIG. 5 is a timing chart illustrating voltage waveforms of the respective components when the pixel of FIG. 2 performs a third read operation;

FIG. 6 is a circuit diagram illustrating an exemplary pixel configuration of 2×4 pixels in a 2-pixel 1-cell configuration of a solid-state imaging device according to a second embodiment;

FIG. 7 is a circuit diagram illustrating an exemplary pixel configuration of 2×4 pixels in a 4-pixel 1-cell configuration of a solid-state imaging device according to a third embodiment;

FIG. 8 is a circuit diagram illustrating an exemplary pixel configuration of 2×4 pixels in a 4-pixel 1-cell configuration of a solid-state imaging device according to a fourth embodiment;

FIG. 9 is a circuit diagram illustrating an exemplary pixel configuration of 2×4 pixels in a 2-pixel 1-cell configuration of a solid-state imaging device according to a fifth embodiment;

FIG. 10 is a circuit diagram illustrating an exemplary pixel configuration of 2×4 pixels in a 2-pixel 1-cell configuration of a solid-state imaging device according to a sixth embodiment;

FIG. 11 is a circuit diagram illustrating an exemplary pixel configuration of 2×4 pixels in a 2-pixel 1-cell configuration of a solid-state imaging device according to a seventh embodiment;

FIG. 12A is a circuit diagram illustrating an exemplary configuration of a switching transistor applied to a solid-state imaging device according to an eighth embodiment, and FIG. 12B is a plane view illustrating an exemplary layout configuration of the switching transistor of FIG. 12A;

FIG. 13A is a circuit diagram illustrating an exemplary configuration of a switching transistor applied to a solid-state imaging device according to a ninth embodiment, and FIG. 13B is a plane view illustrating an exemplary layout configuration of the switching transistor of FIG. 13A;

FIG. 14A is a circuit diagram illustrating an exemplary configuration of a switching transistor applied to a solid-state imaging device according to a tenth embodiment, and FIG. 14B is a plane view illustrating an exemplary layout configuration of the switching transistor of FIG. 14A;

FIG. 15A is a circuit diagram illustrating an exemplary configuration of a switching transistor applied to a solid-state imaging device according to an eleventh embodiment, and FIG. 15B is a plane view illustrating an exemplary layout configuration of the switching transistor of FIG. 15A; and

FIG. 16 is a block diagram illustrating a schematic configuration of a digital camera to which a solid-state imaging device according to a twelfth embodiment.

### DETAILED DESCRIPTION

According to one embodiment, a solid-state imaging device includes a pixel array unit and a switching transistor. The pixel array unit includes pixels that accumulate charges obtained by photoelectric conversion and are arranged in a row direction and a column direction. The switching transistor is disposed between the pixels, performs an operation of changing a voltage conversion gain (mV/ele) by connecting signal charge voltage converting units that convert signal charges accumulated by the pixels into a voltage, and causes the pixels to perform a binning operation.

Hereinafter, exemplary embodiments of a solid-state imaging device will be described below in detail with reference to the accompanying drawings. The present invention is not limited to the following embodiments.

### First Embodiment

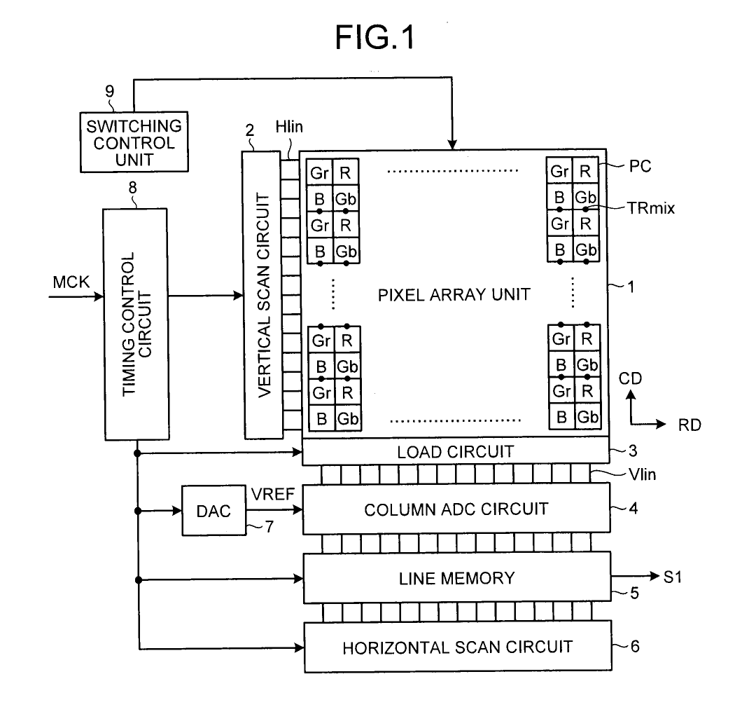

FIG. 1 is a block diagram illustrating a schematic configuration of a solid-state imaging device according to a first embodiment.

Referring to FIG. 1, a solid-state imaging device is provided with a pixel array unit 1. In the pixel array unit 1, pixels PC each of which accumulates charges obtained by photoelectric conversion are arranged in the form of an m×n matrix (m is a positive integer, and n is a positive integer) in which m pixels are arranged in a row direction RD, and n pixels are arranged in a column direction CD. In the pixel array unit 1, horizontal control lines Hlin used to control reading of the pixels PC are disposed in the row direction RD, and vertical signal lines Vlin used to transfer signals read from the pixels PC are disposed in the column direction CD. The pixel PC may configure the Bayer array including two green pixels Gr and Gb, one red pixel R, and one blue pixel B. Further, in the pixel array unit 1, a switching transistor TRmix that causes the pixels PC to perform the binning operation is disposed between the pixels PC. The switching transistor TRmix may be disposed between the pixels PC neighboring in the column direction CD. When a pixel configuration in which a voltage converting unit that converts charges accumulated in the pixel PC into a voltage is shared by a plurality of pixels PC, the switching transistor TRmix may be disposed between the cells.

The solid-state imaging device is further provided with a vertical scan circuit 2 that scans the pixels PC of the reading target in the vertical direction, a load circuit 3 that performs a source follower operation with the pixels PC and reads pixel signals from the pixels PC to the vertical signal line Vlin in units of columns, a column ADC circuit 4 that performs a CDS process for extracting only signal components of the pixels PC and performs conversion into a digital signal, a line memory 5 that stores the signal components of the pixels PC detected by the column ADC circuit 4 in units of columns, a horizontal scan circuit 6 that scans the pixels PC of the reading target in the horizontal direction, a reference voltage generating circuit 7 that outputs a reference voltage VREF to the column ADC circuit 4, a timing control circuit 8 that controls reading timings and accumulation timings of the pixels PC, and a switching control unit 9 that performs switching control on the transistor TRmix. A master clock MCK is input to the timing control circuit 8. A ramp wave may be used as the reference voltage VREF. For example, in a still image mode, the switching control unit 9 may turn off the switching transistor TRmix so that signals are individually read from the pixels PC. Further, in a moving image mode or a monitor mode, the switching control unit 9 may turn on the switching transistor TRmix so that the pixels PC perform the binning operation. The switching transistor TRmix may be controlled such that all division transistors are simultaneously controlled or such that division transistors are controlled in units of horizontal control lines Hlin in synchronization with the vertical scan circuit 2.

When the switching transistor TRmix is turned off, the vertical scan circuit 2 scans the pixels PC in the vertical direction in units of lines, and thus the pixels PC are selected in the row direction RD. The load circuit 3 performs the source follower operation with the pixels PC in units of columns, and thus the pixel signals read from the pixels PC are transferred to the column ADC circuit 4 via the vertical signal line Vlin. In the reference voltage generating circuit 7, the ramp wave is set as the reference voltage VREF and transferred to the column ADC circuit 4. The column ADC circuit 4 performs conversion into a digital signal by performing a clock count operation until a signal level and a reset level read from the pixel PC match levels of the ramp wave. At this time, a difference between the signal level and the reset level is obtained, and thus the signal component of each pixel PC is detected through the CDS and output via the line memory 5 as the output signal S1.

Meanwhile, when the switching transistor TRmix is turned on, the vertical scan circuit 2 scans the pixels PC in units of two lines in the vertical direction, and thus the pixels PC of the same color of the two lines in the row direction RD are selected. Then, the load circuit 3 performs the source follower operation with the pixels PC of the two lines in units of columns, and thus the pixel signals read from the pixels PC of the two lines are transferred to the column ADC circuit 4 via the vertical signal lines Vlin. In the reference voltage generating circuit 7, the ramp wave is set as the reference voltage VREF and transferred to the column ADC circuit 4. Then, the column ADC circuit 4 performs conversion into a digital signal by performing a clock count operation until a signal level and a reset level read from the pixels PC of the two lines match levels of the ramp wave. At this time, a difference between the signal level and the reset level is obtained, and thus the signal components of the pixels PC are detected through the CDS and output via the line memory 5 as the output signal S1.

Here, when the switching transistor TRmix is turned off, it is possible to reduce the capacity of the voltage converting unit that converts charges accumulated in the pixel PC into a voltage to be smaller than when the switching transistor TRmix is turned on. Thus, when the pixels PC are caused not to perform the binning operation, it is possible to increase the conversion gain and improve an SN ratio compared to when the pixels PC are caused to perform the binning operation.

Meanwhile, when the pixels PC are caused to perform the binning operation, it is possible to read signals from the pixels PC in units of two lines, and thus it is possible to double the read speed. Further, it is possible to perform the source follower operations with the pixels PC of the two lines in parallel, and it is possible to reduce noise of the pixel signals transferred via the vertical signal lines Vlin to 1/√2.

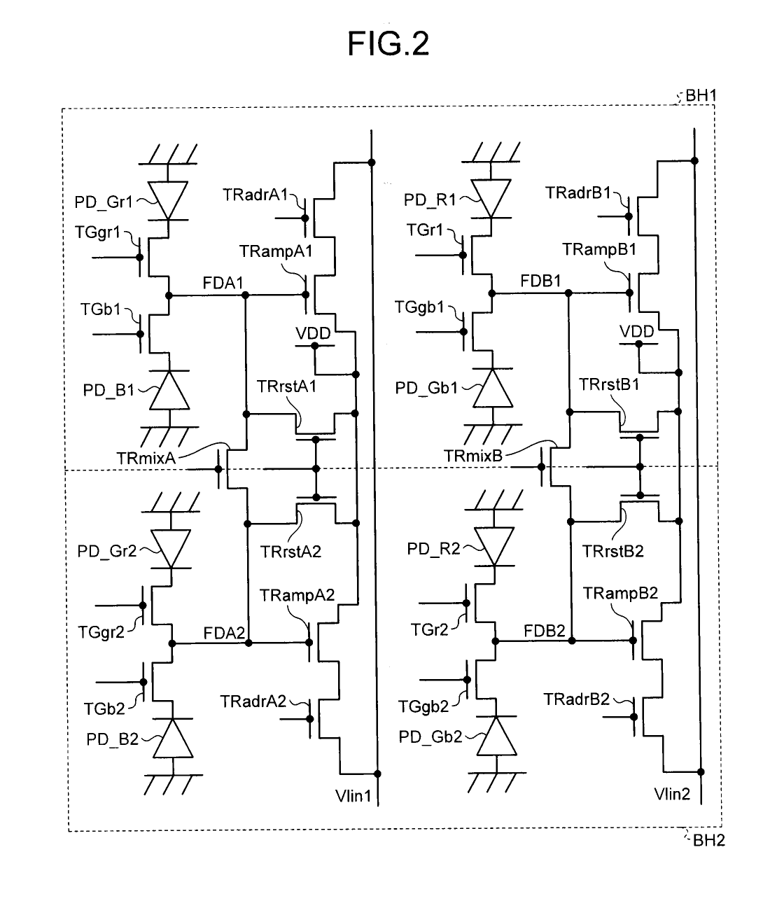

FIG. 2 is a circuit diagram illustrating an exemplary pixel configuration of 2×4 pixels in a 2-pixel 1-cell configuration of the solid-state imaging device of FIG. 1.

Referring to FIG. 2, Bayer arrays BH1 and BH2 are arranged to be adjacent in the column direction CD.

In the Bayer array BH1, a photo diode PD_Gr1 is disposed for the green pixel Gr, a photo diode PD_B1 is disposed for the blue pixel B, a photo diode PD_R1 is disposed for the red pixel R, and a photo diode PD_Gb1 is disposed for the green pixel Gb. The Bayer array BH1 is further provided with row selecting transistors TRadrA1 and TRadrB1, amplifying transistors TRampA1 and TRampB1, reset transistors TRrstA1 and TRrstB1, and read transistors TGgr1, TGb1, TGr1, and TGgb1. A floating diffusion FDA1 is formed at a connection point of the amplifying transistor TRampA1, the reset transistor TRrstA1, and the read transistors TGgr1 and TGb1 as a voltage converting unit. A floating diffusion FDB1 is formed at a connection point of the amplifying transistor TRampB1, the reset transistor TRrstB1, and the read transistors TGr1 and TGgb1 as a voltage converting unit. Here, a 2-pixel 1-cell configuration is made such that the photo diodes PD_Gr1 and PD_B1 share the floating diffusion FDA1, and a 2-pixel 1-cell configuration is made such that the photo diodes PD_R1 and PD_Gb1 share the floating diffusion FDB1.

The photo diode PD_Gr1 is connected to the floating diffusion FDA1 via the read transistor TGgr1, and the photo diode PD_B1 is connected to the floating diffusion FDA1 via the read transistor TGb1. A gate of the amplifying transistor TRampA1 is connected to the floating diffusion FDA1, a source of the amplifying transistor TRampA1 is connected to a vertical signal line Vlin1 via the row selecting transistor TRadrA1, and a drain of the amplifying transistor TRampA1 is connected to a power potential VDD. The floating diffusion FDA1 is connected to the power potential VDD via the reset transistor TRrstA1.

The photo diode PD_R1 is connected to the floating diffusion FDB1 via the read transistor TGr1, and the photo diode PD_Gb1 is connected to the floating diffusion FDB1 via the read transistor TGgb1. A gate of the amplifying transistor TRampB1 is connected to the floating diffusion FDB1, a source of the amplifying transistor TRampB1 is connected to a vertical signal line Vlin2 via the row selecting transistor TRadrB1, and a drain of the amplifying transistor TRampB1 is connected to the power potential VDD. The floating diffusion FDB1 is connected to the power potential VDD via the reset transistor TRrstB1.

In the Bayer array BH2, a photo diode PD_Gr2 is disposed for the green pixel Gr, a photo diode PD_B2 is disposed for the blue pixel B, a photo diode PD_R2 is disposed for the red pixel R, and a photo diode PD_Gb2 is disposed for the green pixel Gb. The Bayer array BH2 is also provided with row selecting transistors TRadrA2 and TRadrB2, amplifying transistors TRampA2 and TRampB2, reset transistors TRrstA2 and TRrstB2, and read transistors TGgr2, TGb2, TGr2, and TGgb2 are disposed. A floating diffusion FDA2 is formed at a connection point of the amplifying transistor TRampA2, the reset transistor TRrstA2, and the read transistors TGgr2 and TGb2 as the voltage converting unit. A floating diffusion FDB2 is formed at a connection point of the amplifying transistor TRampB2, the reset transistor TRrstB2, and the read transistors TGr2 and TGgb2 as the voltage converting unit. Here, a 2-pixel 1-cell configuration is made such that the photo diodes PD_Gr2 and PD_B2 share the floating diffusion FDA2, and a 2-pixel 1-cell configuration is made such that the photo diodes PD_R2 and PD_Gb2 share the floating diffusion FDB2.

The photo diode PD_Gr2 is connected to the floating diffusion FDA2 via the read transistor TGgr2, and the photo diode PD_B2 is connected to the floating diffusion FDA2 via the read transistor TGb2. A gate of the amplifying transistor TRampA2 is connected to the floating diffusion FDA2, a source of the amplifying transistor TRampA2 is connected to the vertical signal line Vlin1 via the row selecting transistor TRadrA2, and a drain of the amplifying transistor TRampA2 is connected to the power potential VDD. The floating diffusion FDA2 is connected to the power potential VDD via the reset transistor TRrstA2.

The photo diode PD_R2 is connected to the floating diffusion FDB2 via the read transistor TGr2, and the photo diode PD_Gb2 is connected to the floating diffusion FDB2 via the read transistor TGgb2. A gate of the amplifying transistor TRampB2 is connected to the floating diffusion FDB2, a source of the amplifying transistor TRampB2 is connected to the vertical signal line Vlin2 via the row selecting transistor TRadrB2, and a drain of the amplifying transistor TRampB2 is connected to the power potential VDD. The floating diffusion FDB2 is connected to the power potential VDD via the reset transistor TRrstB2. Further, signals can be input to the gates of the row selecting transistor TRadrA1, TRadrB1, TRadrA2, and TRadrB2, the reset transistor TRrstA1, TRrstB1, TRrstA2, and TRrstB2, and the read transistors TGgr1, TGb1, TGr1, TGgb1, TGgr2, TGb2, TGr2, and TGgb2 via the horizontal control lines Hlin.

The floating diffusions FDA1 and FDA2 are connected to each other via the switching transistor TRmixA, and the floating diffusions FDB1 and FDB2 are connected to each other via the switching transistor TRmixB. Further, signals can be input from the switching control unit 9 to the gates of the switching transistors TRmixA and TRmixB.

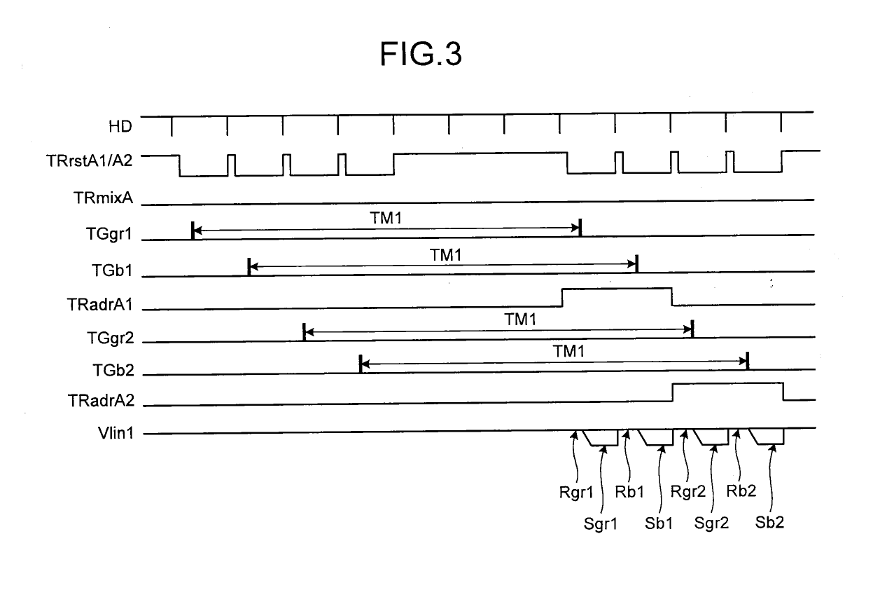

FIG. 3 is a timing chart illustrating voltage waveforms of the respective components when the pixel of FIG. 2 performs a first read operation. The example of FIG. 3 illustrates a read operation to the vertical signal line Vlin1 of FIG. 2.

Referring to FIG. 3, in the first read operation, as the switching transistor TRmixA is turned off, the floating diffusions FDA1 and FDA2 are separated from each other.

Then, as the read transistor TGgr1 is turned on, the residual charges of the photo diode PD_Gr1 are discharged to the floating diffusion FDA1. Thereafter, as the read transistor TGgr1 is turned off, an operation of accumulating the signal charges in the photo diode PD_Gr1 starts.

Then, as the reset transistor TRrstA1 is turned on, the charges of the floating diffusion FDA1 are discharged, and then as the read transistor TGb1 is turned on, the residual charges of the photo diode PD_B1 are discharged to the floating diffusion FDA1. Thereafter, as the read transistor TGb1 is turned off, an operation of accumulating the signal charges in the photo diode PD_B1 starts.

Then, as the reset transistor TRrstA2 is turned on, the charges of the floating diffusion FDA2 are discharged, and then as the read transistor TGgr2 is turned on, the residual charges of the photo diode PD_Gr2 are discharged to the floating diffusion FDA2. Thereafter, as the read transistor TGgr2 is turned off, an operation of accumulating the signal charges in the photo diode PD_Gr2 starts.

Then, as the reset transistor TRrstA2 is turned on, the charges of the floating diffusion FDA2 are discharged, and then as the read transistor TGb2 is turned on, the residual charges of the photo diode PD_B2 are discharged to the floating diffusion FDA2. Thereafter, as the read transistor TGb2 is turned off, an operation of accumulating the signal charges in the photo diode PD_B2 starts.

Then, the row selecting transistor TRadrA1 is turned on when the read transistor TGgr1 is in the off state, and thus the amplifying transistor TRampA1 performs the source follower operation, and a voltage according to charges of a black level of the floating diffusion FDA1 is read out to the vertical signal line Vlin1. Then, a pixel signal Rgr1 of the black level is detected based on the voltage of the vertical signal line Vlin1 at this time. Thereafter, as the read transistor TGgr1 is turned on, the signal charges of the photo diode PD_Gr1 are read out to the floating diffusion FDA1. Then, the amplifying transistor TRampA1 performs the source follower operation, and thus a voltage according to charges of the signal level of the floating diffusion FDA1 are read out to the vertical signal line Vlin1. Then, a pixel signal Sgr1 of the signal level is detected based on the voltage of the vertical signal line Vlin1 at this time. Then, a difference between the pixel signal Sgr1 of the signal level and the pixel signal Rgr1 of the black level is obtained, and thus a signal component according to the charges accumulated in the photo diode PD_Gr1 is detected. At this time, the accumulation period of time of the photo diode PD_Gr1 is TM1.

Then, as the reset transistor TRrstA1 is turned on, the charges of the floating diffusion FDA1 are discharged. Then, when the read transistor TGb1 is turned off, and the row selecting transistor TRadrA1 is turned on, the amplifying transistor TRampA1 performs the source follower operation, and thus the voltage according to the charges of the black level of the floating diffusion FDA1 are read out to the vertical signal line Vlin1. Then, a pixel signal Rb1 of the black level is detected based on the voltage of the vertical signal line Vlin1 at this time. Thereafter, the read transistor TGb1 is turned on, and the signal charges of the photo diode PD_B1 are read out to the floating diffusion FDA1. Then, the amplifying transistor TRampA1 performs the source follower operation, and thus the voltage according to the charges of the signal level of the floating diffusion FDA1 is read out to the vertical signal line Vlin1. Then, a pixel signal Sb1 of the signal level is detected based on the voltage of the vertical signal line Vlin1 at this time. Then, a difference between the pixel signal Sb1 of the signal level and the pixel signal Rb1 of the black level is obtained, and thus a signal component according to the charges accumulated in the photo diode PD_B1 is detected. At this time, the accumulation period of time of the photo diode PD_B1 is TM1.

Then, as the reset transistor TRrstA2 is turned on, the charges of the floating diffusion FDA2 are discharged. Then, the row selecting transistor TRadrA2 is turned on when the read transistor TGgr2 is in the off state, and thus the amplifying transistor TRampA2 performs the source follower operation, the voltage according to the charges of the black level of the floating diffusion FDA2 is read out to the vertical signal line Vlin1. Then, a pixel signal Rgr2 of the black level is detected based on the voltage of the vertical signal line Vlin1 at this time. Thereafter, as the read transistor TGgr2 is turned on, the signal charges of the photo diode PD_Gr2 are read out to the floating diffusion FDA2. Then, the amplifying transistor TRampA2 performs the source follower operation, and thus the voltage according to the charges of the signal level of the floating diffusion FDA2 is read out to the vertical signal line Vlin1. Then, a pixel signal Sgr2 of the signal level is detected based on the voltage of the vertical signal line Vlin1 at this time. Then, a difference between the pixel signal Sgr2 of the signal level and the pixel signal Rgr2 of the black level is obtained, and thus a signal component according to the charges accumulated in the photo diode PD_Gr2 is detected. At this time, the accumulation period of time of the photo diode PD_Gr2 is TM1.

Then, as the reset transistor TRrstA2 is turned on, the charges of the floating diffusion FDA2 are discharged. Then, when the read transistor TGb2 is turned off, and the row selecting transistor TRadrA2 is turned on, the amplifying transistor TRampA2 performs the source follower operation, and thus the voltage according to the charges of the black level of the floating diffusion FDA2 is read out to the vertical signal line Vlin1. Then, a pixel signal Rb2 of the black level is detected based on the voltage of the vertical signal line Vlin1 at this time. Thereafter, as the read transistor TGb2 is turned on, the signal charges of the photo diode PD_B2 are read out to the floating diffusion FDA2. Then, the amplifying transistor TRampA2 performs the source follower operation, and thus the voltage according to the charges of the signal level of the floating diffusion FDA2 is read out to the vertical signal line Vlin1. Then, a pixel signal Sb2 of the signal level is detected based on the voltage of the vertical signal line Vlin1 at this time. Then, a difference between the pixel signal Sb2 of the signal level and the pixel signal Rb2 of the black level is obtained, and thus a signal component according to the charges accumulated in the photo diode PD_B2 is detected. At this time, the accumulation period of time of the photo diode PD_B2 is TM1. The pixel signals Rgr1, Rb1, Rgr2, and Rb2 of the black level and the pixel signals Sgr1, Sb1, Sgr2, and Sb2 of the signal level can be sequentially read out in synchronization with the horizontal synchronous signal HD and completed with four cycles.

Here, in the first read operation, it is possible to separate the floating diffusions FDA1 and FDA2 through the switching transistor TRmixA, and it is possible to reduce the capacity of the voltage converting unit that converts charges accumulated in the pixel PC into a voltage. Thus, when the pixels PC are caused not to perform the binning operation, it is possible to increase the conversion gain and improve an SN ratio compared to when the pixels PC are caused to perform the binning operation.

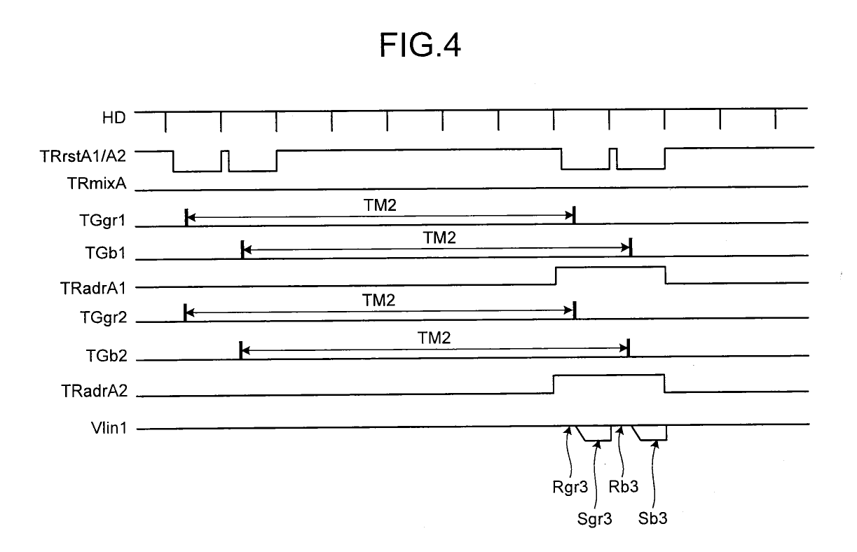

FIG. 4 is a timing chart illustrating voltage waveforms of the respective components when the pixel of FIG. 2 performs a second read operation. The example of FIG. 4 illustrates a read operation to the vertical signal line Vlin1 of FIG. 2.

Referring to FIG. 4, in the second read operation, as the switching transistor TRmixA is turned on, the floating diffusions FDA1 and FDA2 are combined.

Then, as the read transistors TGgr1 and TGgr2 are turned on, the residual charges of the photo diodes PD_Gr1 and PD_Gr2 are discharged to the floating diffusions FDA1 and FDA2. Thereafter, as the read transistors TGgr1 and TGgr2 is turned off, an operation of accumulating the signal charges in the photo diodes PD_Gr1 and PD_Gr2 starts.

Then, as the reset transistors TRrstA1 and TRrstA2 are turned on, the charges of the floating diffusions FDA1 and FDA2 are discharged, and as the read transistors TGb1 and TGb2 are turned on, the residual charges of the photo diodes PD_B1 and PD_B2 are discharged to the floating diffusions FDA1 and FDA2. Thereafter, as the read transistors TGb1 and TGb2 is turned off, an operation of accumulating the signal charges in the photo diodes PD_B1 and PD_B2 starts.

Then, the row selecting transistors TRadrA1 and TRadrA2 are turned on when the read transistors TGgr1 and TGgr2 are in the off state, and thus the amplifying transistors TRampA1 and TRampA2 perform the source follower operation, and the voltage according to the charges of the black level of the floating diffusions FDA1 and FDA2 is read out to the vertical signal line Vlin1. Then, a pixel signal Rgr3 of the black level is detected based on the voltage of the vertical signal line Vlin1 at this time. Thereafter, as the read transistors TGgr1 and TGgr2 are turned on, the signal charges of the photo diodes PD_Gr1 and PD_Gr2 are read out to the floating diffusions FDA1 and FDA2. Then, the amplifying transistors TRampA1 and TRampA2 perform the source follower operation, and thus the voltage according to the charges of the signal level of the floating diffusions FDA1 and FDA2 is read out to the vertical signal line Vlin1. Then, a pixel signal Sgr3 of the signal level is detected based on the voltage of the vertical signal line Vlin1 at this time. Then, a difference between the pixel signal Sgr3 of the signal level and the pixel signal Rgr3 of the black level is obtained, and thus binned signal components according to the charges accumulated in the photo diodes PD_Gr1 and PD_Gr2 are detected. At this time, the accumulation periods of time of the photo diodes PD_Gr1 and PD_Gr2 is TM2.

Then, as the reset transistors TRrstA1 and TRrstA2 are turned on, the charges of the floating diffusions FDA1 and FDA2 are discharged. Then, when the read transistors TGb1 and TGb2 are turned off, the row selecting transistors TRadrA1 and TRadrA2 are turned on, the amplifying transistors TRampA1 and TRampA2 perform the source follower operation, and thus the voltage according to the charges of the black level of the floating diffusions FDA1 and FDA2 is read out to the vertical signal line Vlin1. Then, a pixel signal Rb3 of the black level is detected based on the voltage of the vertical signal line Vlin1 at this time. Thereafter, as the read transistors TGb1 and TGb2 are turned on, the signal charges of the photo diodes PD_B1 and PD_B2 are read out to the floating diffusions FDA1 and FDA2. Then, the amplifying transistors TRampA1 and TRampA2 perform the source follower operation, and thus the voltage according to the charges of the signal level of the floating diffusions FDA1 and FDA2 is read out to the vertical signal line Vlin1. Then, a pixel signal Sb3 of the signal level is detected based on the voltage of the vertical signal line Vlin1 at this time. Then, a difference between the pixel signal Sb3 of the signal level and the pixel signal Rb3 of the black level is obtained, and thus binned signal components according to the charges accumulated in the photo diodes PD_B1 and PD_B2 are detected. At this time, the accumulation periods of time of the photo diodes PD_B1 and PD_B2 are TM2. The pixel signals Rgr3 and Rb3 of the black level and the pixel signals Sgr3 and Sb3 of the signal level can be sequentially read out in synchronization with the horizontal synchronous signal HD and completed with two cycles.

Here, in the second read operation, it is possible to combine the floating diffusions FDA1 and FDA2 through the switching transistor TRmixA, it is possible to read signals from the pixels PC in units of two lines, and thus it is possible to double the read speed. Further, it is possible to cause the amplifying transistors TRampA1 and TRampA2 of two lines to perform the source follower operation in parallel, and it is possible to reduce noise of the pixel signals Rgr3 and Rb3 of the black level and the pixel signals Sgr3 and Sb3 of the signal level transferred via the vertical signal line Vlin1 to 1/√2.

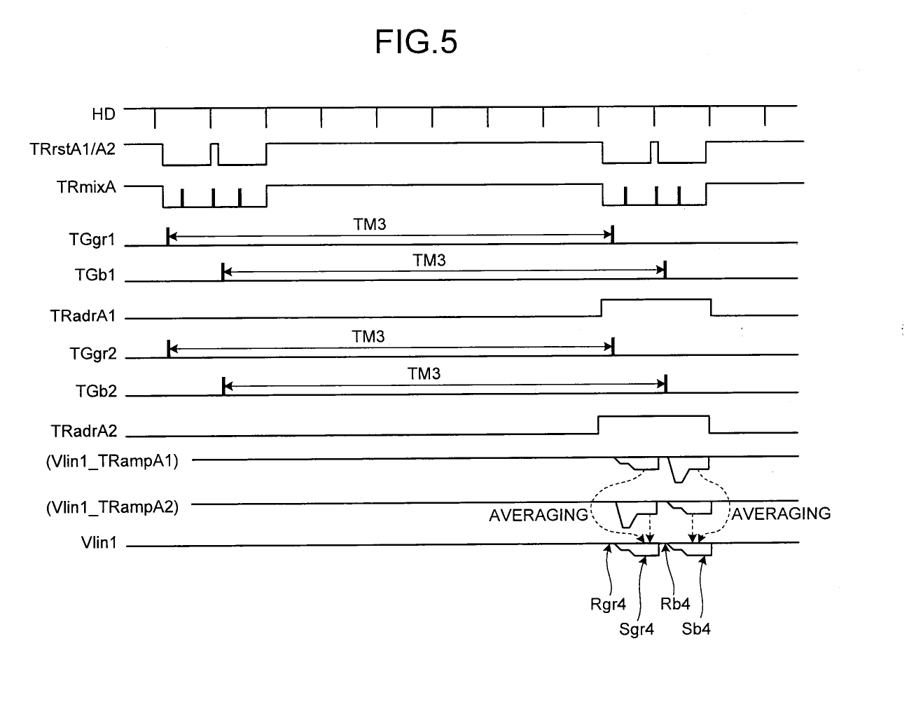

FIG. 5 is a timing chart illustrating voltage waveforms of the respective components when the pixel of FIG. 2 performs a third read operation. The example of FIG. 5 illustrates a read operation to the vertical signal line Vlin1 of FIG. 2.

Referring to FIG. 5, as the switching transistor TRmixA is turned off, the floating diffusions FDA1 and FDA2 are separated from each other.

Then, as the read transistors TGgr1 and TGgr2 are turned on, the residual charges of the photo diodes PD_Gr1 and PD_Gr2 are discharged to the floating diffusions FDA1 and FDA2. Thereafter, as the read transistors TGgr1 and TGgr2 are turned off, an operation of accumulating the signal charges in the photo diodes PD_Gr1 and PD_Gr2 starts.

Then, as the switching transistor TRmixA is turned on, the floating diffusions FDA1 and FDA2 are combined. Then, as the reset transistors TRrstA1 and TRrstA2 is turned on, the charges of the floating diffusions FDA1 and FDA2 are discharged. Then, as the switching transistor TRmixA is turned off, the floating diffusions FDA1 and FDA2 are separated from each other. Then, as the read transistors TGb1 and TGb2 is turned on, the residual charges of the photo diodes PD_B1 and PD_B2 are discharged to the floating diffusions FDA1 and FDA2. Thereafter, as the read transistors TGb1 and TGb2 are turned off, an operation of accumulating the signal charges in the photo diodes PD_B1 and PD_B2 starts.

Then, the row selecting transistors TRadrA1 and TRadrA2 are turned on when the read transistors TGgr1 and TGgr2 is in the off state, and thus the amplifying transistors TRampA1 and TRampA2 perform the source follower operation, the voltage according to the charges of the black level of the floating diffusions FDA1 and FDA2 is read out to the vertical signal line Vlin1. Then, a pixel signal Rgr4 of the black level is detected based on the voltage of the vertical signal line Vlin1 at this time. Thereafter, as the read transistors TGgr1 and TGgr2 are turned on, the signal charges of the photo diodes PD_Gr1 and PD_Gr2 are read out to the floating diffusions FDA1 and FDA2. At this time, as the switching transistor TRmixA is turned on, the signal charged read out to the floating diffusions FDA1 and FDA2 are averaged. Then, as the switching transistor TRmixA is turned off, the floating diffusions FDA1 and FDA2 are separated from each other, and then the amplifying transistors TRampA1 and TRampA2 perform the source follower operation, and thus the voltage according to the charges of the signal level of the floating diffusions FDA1 and FDA2 is read out to the vertical signal line Vlin1. Then, a pixel signal Sgr4 of the signal level is detected based on the voltage of the vertical signal line Vlin1 at this time. Then, a difference between the pixel signal Sgr4 of the signal level and the pixel signal Rgr4 of the black level is obtained, and thus the binned signal component according to the charges accumulated in the photo diodes PD_Gr1 and PD_Gr2 is detected. At this time, the accumulation periods of time of the photo diodes PD_Gr1 and PD_Gr2 are TM3.

Then, as the switching transistor TRmixA is turned on, the floating diffusions FDA1 and FDA2 are combined. Then, as the reset transistors TRrstA1 and TRrstA2 is turned on, the charges of the floating diffusions FDA1 and FDA2 are discharged. Then, as the switching transistor TRmixA is turned off, the floating diffusions FDA1 and FDA2 are separated from each other. Then, when the read transistors TGb1 and TGb2 are turned off, and the row selecting transistors TRadrA1 and TRadrA2 are turned on, the amplifying transistors TRampA1 and TRampA2 perform the source follower operation, and thus the voltage according to the charges of the black level of the floating diffusions FDA1 and FDA2 is read out to the vertical signal line Vlin1. Then, a pixel signal Rb4 of the black level is detected based on the voltage of the vertical signal line Vlin1 at this time. Thereafter, as the read transistors TGb1 and TGb2 is turned on, the signal charges of the photo diodes PD_B1 and PD_B2 are read out to the floating diffusions FDA1 and FDA2. At this time, as the switching transistor TRmixA is turned on, the signal charged read out to the floating diffusions FDA1 and FDA2 are averaged. Then, as the switching transistor TRmixA is turned off, the floating diffusions FDA1 and FDA2 are separated from each other, and then the amplifying transistors TRampA1 and TRampA2 perform the source follower operation, and thus the voltage according to the charges of the signal level of the floating diffusions FDA1 and FDA2 is read out to the vertical signal line Vlin1. Then, a pixel signal Sb4 of the signal level is detected based on the voltage of the vertical signal line Vlin1 at this time. Then, a difference between the pixel signal Sb4 of the signal level and the pixel signal Rb4 of the black level is obtained, and thus the binned signal components according to the charges accumulated in the photo diodes PD_B1 and PD_B2 is detected. At this time, the accumulation periods of time of the photo diodes PD_B1 and PD_B2 are TM3. The pixel signals Rgr4 and Rb4 of the black level and the pixel signals Sgr4 and Sb4 of the signal level can be sequentially read out in synchronization with the horizontal synchronous signal HD and completed with two cycles.

Here, in the third read operation, it is possible to cause the amplifying transistors TRampA1 and TRampA2 of two lines to perform the source follower operation in parallel, and it is possible to reduce noise of the pixel signals Rgr4 and Rb4 of the black level and the pixel signals Sgr4 and Sb4 of the signal level transferred via the vertical signal line Vlin1 to 1/′2. Further, as the switching transistor TRmixA is turned on after signal reading, it is possible to average the potentials of the floating diffusions FDA1 and FDA2, and it is possible to cause a potential difference of the floating diffusions FDA1 and FDA2 to be about 10 mV. Thus, even when there is a potential difference of 0.3 V to 0.5 V between the floating diffusions FDA1 and FDA2 after signal reading, the signal averaged by the source follower operation can be output to the vertical signal line Vlin1.

In the first read operation of FIG. 3, it is possible to separate the floating diffusions FDA1 and FDA2 through the switching transistor TRmixA, and it is possible to reduce the capacity of the voltage converting unit that converts charges accumulated in the pixel PC into a voltage. Thus, it is possible to increase the conversion gain and improve an SN ratio. Particularly, as a high conversion gain is set so that the saturation capacity of the floating diffusion FDA is smaller than the saturation capacity of the photo diode PD, a signal having a high SN ratio can be obtained at the time of shooting in a dark condition in which a signal charge amount is small. At the time of shooting in a bright condition, the saturation capacity of the FDA is increased by connecting the floating diffusions FDA1 and FDA2 with each other through the switching transistor TRmixA, and thus it is possible to convert saturation signal charges of the photo diode PD into a signal voltage and output the signal voltage. Further, similarly to FIG. 4 and FIG. 5, it is possible to cause the amplifying transistors TRampA1 and TRampA2 to perform the source follower operation in parallel, and it is possible to reduce the noise of the amplifying transistor to 1/√2.

### Second Embodiment

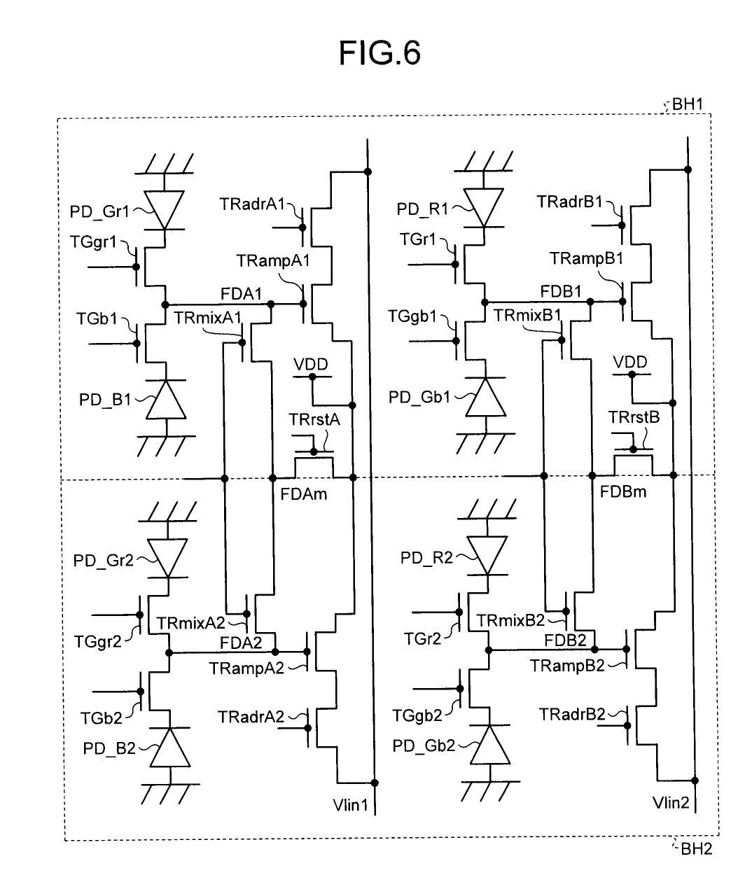

FIG. 6 is a circuit diagram illustrating an exemplary pixel configuration of 2×4 pixels in a 2-pixel 1-cell configuration of a solid-state imaging device according to second embodiment.

Referring to FIG. 6, in the solid-state imaging device, switching transistors TRmixA1, TRmixA2, TRmixB1, and TRmixB2 are disposed instead of the switching transistors TRmixA and TRmixB of FIG. 2. Further, reset transistors TRrstA and TRrstB are disposed instead of the reset transistors TRrstA1, TRrstB1, TRrstA2, and TRrstB2 of FIG. 2.

The switching transistors TRmixA1 and TRmixA2 are connected with each other in series, and the serial circuit is connected between the floating diffusions FDA1 and FDA2. The gates of the switching transistors TRmixA1 and TRmixA2 are mutually connected with each other. The reset transistor TRrstA is connected between the connection point of the switching transistors TRmixA1 and TRmixA2 and the power potential VDD. The floating diffusion FDAm is formed at the connection point of the switching transistors TRmixA1 and TRmixA2. The switching transistor TRmixA1 can be arranged near the floating diffusion FDA1. The switching transistor TRmixA2 can be arranged near the floating diffusion FDA2.

The switching transistors TRmixB1 and TRmixB2 are connected to each other in series, and the serial circuit is connected between the floating diffusions FDB1 and FDB2. The gates of the switching transistors TRmixB1 and TRmixB2 are mutually connected with each other. The reset transistor TRrstB is connected to between a connection point of the switching transistors TRmixB1 and TRmixB2 and the power potential VDD. The floating diffusion FDBm is formed at the connection point of the switching transistors TRmixB1 and TRmixB2. The switching transistor TRmixB1 may be arranged to be adjacent to the floating diffusion FDB1. The switching transistor TRmixB2 may be arranged to be adjacent the floating diffusion FDB2.

The switching transistors TRmixA1 and TRmixA2 may operate, similarly to the switching transistor TRmixA, and the switching transistors TRmixB1 and TRmixB2 may operate, similarly to the switching transistor TRmixB. The reset transistor TRrstA may operate, similarly to the reset transistors TRrstA1 and TRrstA2, and the reset transistor TRrstB may operate, similarly to the reset transistors TRrstB1 and TRrstB2.

Here, as the switching transistors TRmixA1, TRmixA2, TRmixB1, and TRmixB2 are arranged to be adjacent to the floating diffusions FDA1, FDA2, FDB1, and FDB2, it is possible to reduce the interconnection capacity added to the floating diffusions FDA1, FDA2, FDB1, and FDB2 in the first read operation of FIG. 3, and it is possible to increase the conversion gain. In addition, it is possible to replace the two reset transistors TRrstA1 and TRrstA2 of FIG. 2 with one transistor. Similarly, the two reset transistors TRrstB1 and TRrstB2 can be replaced with one transistor.

### Third Embodiment

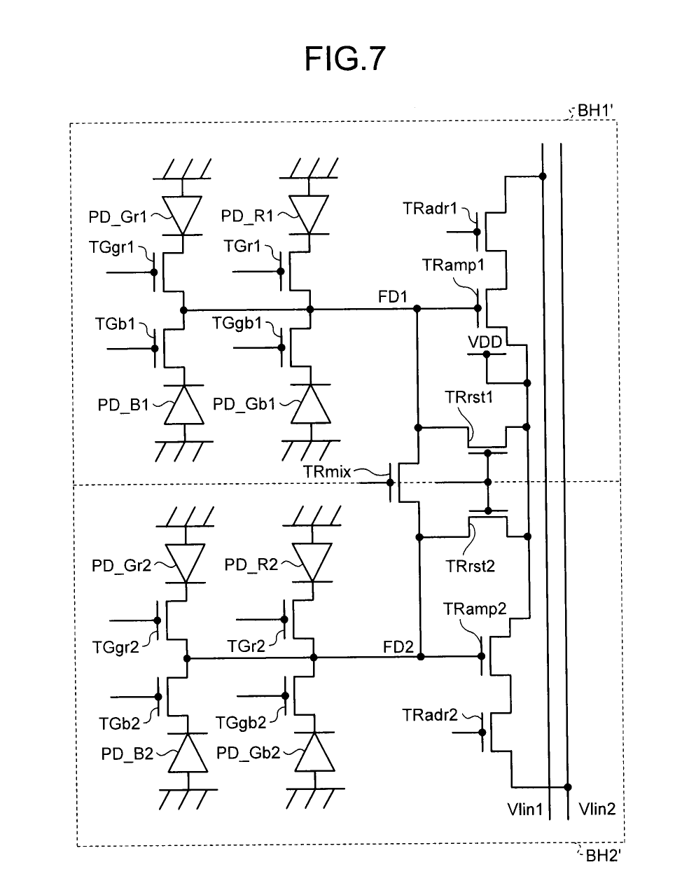

FIG. 7 is a circuit diagram illustrating an exemplary pixel configuration of 2×4 pixels in a 4-pixel 1-cell configuration of a solid-state imaging device according to a third embodiment.

Referring to FIG. 7, in the solid-state imaging device, Bayer arrays BH1′ and BH2′ are disposed instead of the Bayer arrays BH1 and BH2 of FIG. 2. In the Bayer array BH1′, a floating diffusion FD1 is disposed instead of the floating diffusions FDA1 and FDB1 of FIG. 2, a row selecting transistor TRadr1 is disposed instead of the row selecting transistors TRadrA1 and TRadrB1 of FIG. 2, and a amplifying transistor TRamp1 is disposed instead of the amplifying transistors TRampA1 and TRampB1 of FIG. 2. Here, a 4-pixel 1-cell configuration is made such that the floating diffusion FD1 is shared by photo diodes PD_Gr1, PD_B1, PD_R1, and PD_Gb1.

Then, the photo diode PD_Gr1 is connected to the floating diffusion FD1 via the read transistor TGgr1, the photo diode PD_B1 is connected to the floating diffusion FD1 via the read transistor TGb1, the photo diode PD_R1 is connected to the floating diffusion FD1 via the read transistor TGr1, and the photo diode PD_Gb1 is connected to the floating diffusion FD1 via the read transistor TGgb1. A gate of the amplifying transistor TRamp1 is connected to the floating diffusion FD1, a source of the amplifying transistor TRamp1 is connected to the vertical signal line Vlin1 via the row selecting transistor TRadr1, and a drain of the amplifying transistor TRamp1 is connected to the power potential VDD. Further, the floating diffusion FD1 is connected to the power potential VDD via the reset transistor TRrst1.

In the Bayer array BH2′, the floating diffusion FD2 is disposed instead of the floating diffusions FDA2 and FDB2 of FIG. 2, the row selecting transistor TRadr2 is disposed instead of the row selecting transistors TRadrA2 and TRadrB2 of FIG. 2, and the amplifying transistor TRamp2 is disposed instead of the amplifying transistors TRampA2 and TRampB2 of FIG. 2. Here, a 4-pixel 1-cell configuration is made such that the floating diffusion FD2 is shared by photo diodes PD_Gr2, PD_B2, PD_R2, and PD_Gb2.

Then, the photo diode PD_Gr2 is connected to the floating diffusion FD2 via the read transistor TGgr2, the photo diode PD_B2 is connected to the floating diffusion FD2 via the read transistor TGb2, the photo diode PD_R2 is connected to the floating diffusion FD2 via the read transistor TGr2, and the photo diode PD_Gb2 is connected to the floating diffusion FD2 via the read transistor TGgb2. A gate of the amplifying transistor TRamp2 is connected to the floating diffusion FD2, a source of the amplifying transistor TRamp2 is connected to the vertical signal line Vlin2 via the row selecting transistor TRadr2, and a drain of the amplifying transistor TRamp2 is connected to the power potential VDD. The floating diffusion FD2 is connected to the power potential VDD via the reset transistor TRrst2. The floating diffusions FD1 and FD2 are connected to each other via the switching transistor TRmix.

When the binning operation is not performed between the Bayer arrays BH1′ and BH2′, the switching transistor TRmix is turned off, and signals are individually read from the respective pixels of the Bayer arrays BH1′ and BH2′. When the binning operation is performed between the Bayer arrays BH1′ and BH2′, the switching transistor TRmix is turned on, and signals are simultaneously read from the same color pixels of the Bayer arrays BH1′ and BH2′ and added in the floating diffusions FD1 and FD2.

Here, in the 4-pixel 1-cell configuration, when the binning operation is not performed, it is possible to separate the floating diffusions FD1 and FD2 through the switching transistor TRmix. Thus, it is possible to reduce the capacity of the voltage converting unit that converts charges accumulated in the pixel PC into a voltage, and it is possible to increase the conversion gain.

Further, in the 4-pixel 1-cell configuration, when the binning operation is performed, it is possible to combine the floating diffusions FD1 and FD2 through the switching transistor TRmix. Thus, it is possible to read signals from the pixels PC in units of two lines and thus double the read speed. Furthermore, it is possible to cause the amplifying transistors TRamp1 and TRamp2 of the two lines to perform the source follower operations in parallel, and it is possible to reduce the noise of the pixel signal to 1/√2 by adding or averaging the pixel signals transferred via the vertical signal lines Vlin1 and Vlin2 at a subsequent stage.

### Fourth Embodiment

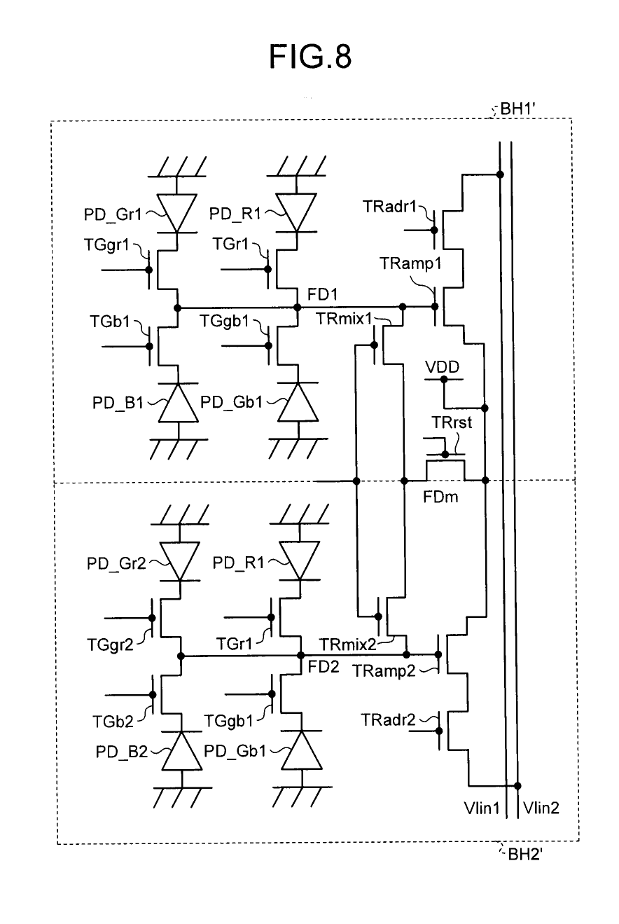

FIG. 8 is a circuit diagram illustrating an exemplary pixel configuration of 2×4 pixels in a 4-pixel 1-cell configuration of a solid-state imaging device according to a fourth embodiment.

Referring to FIG. 8, in the solid-state imaging device, switching transistors TRmix1 and TRmix2 are disposed instead of the switching transistor TRmix of FIG. 7. Further, a reset transistor TRrst is disposed instead of the reset transistors TRrst1 and TRrst2 of FIG. 7.

The switching transistors TRmix1 and TRmix2 are connected to each other in series, and the serial circuit is connected between the floating diffusions FD1 and FD2. The gates of the switching transistors TRmix1 and TRmix2 are mutually connected with each other. The reset transistor TRrst is connected between a connection point of the switching transistors TRmix1 and TRmix2 and the power potential VDD. The floating diffusion FDm is formed at the connection point of the switching transistors TRmix1 and TRmix2. The switching transistor TRmix1 may be arranged to be adjacent to the floating diffusion FD1. The switching transistor TRmix2 may be arranged to be adjacent to the floating diffusion FD2.

The switching transistors TRmix1 and TRmix2 may operate, similarly to the switching transistor TRmix. The reset transistor TRrst may operate, similarly to the reset transistors TRrst1 and TRrst2.

Here, as the switching transistors TRmix1 and TRmix2 are arranged to be adjacent to the floating diffusions FD1 and FD2, it is possible to reduce an interconnection capacity added to the floating diffusions FD1 and FD2, and it is possible to increase the conversion gain. In addition, the two reset transistors TRrst1 and TRrst2 of FIG. 7 can be replaced with one transistor.

### Fifth Embodiment

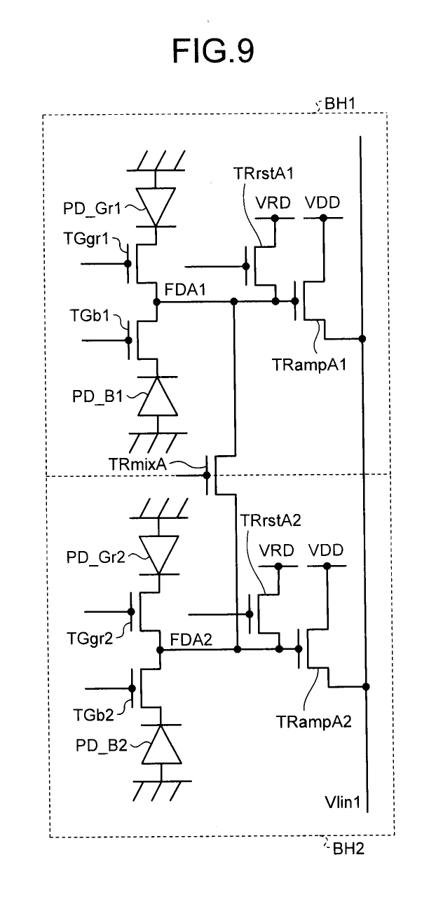

FIG. 9 is a circuit diagram illustrating an exemplary pixel configuration of 2×4 pixels in a 2-pixel 1-cell configuration of a solid-state imaging device according to a fifth embodiment. The example of FIG. 9 illustrates only a configuration for the vertical signal line Vlin1 of FIG. 2.

Referring to FIG. 9, in the solid-state imaging device, the row selecting transistors TRadrA1 and TRadrA2 of FIG. 2 are not provided. Further, in the solid-state imaging device, the floating diffusion FDA1 is connected to a power potential VRD via the reset transistor TRrstA1, and the floating diffusion FDA2 is connected to the power potential VRD via the reset transistor TRrstA2.

Here, in the configuration of FIG. 2, as the row selecting transistors TRadrA1 and TRadrA2 is turned off, non-selection rows are set. On the other hand, in the configuration of FIG. 9, as the power potential VRD is fallen when the reset transistors TRrstA1 and TRrstA2 are in the on state, the amplifying transistors TRampA1 and TRampA2 are turned off, and non-selection rows are set. The remaining components can operate similarly to those of FIG. 2.

Thus, even when the row selecting transistors TRadrA1 and TRadrA2 are removed, it is possible to connect or separate the floating diffusions FDA1 and FDA2 to or from each other through the switching transistor TRmixA. Thus, it is possible to reduce the circuit noise of the amplifying transistor to 1/√2 by turning on the amplifying transistors TRampA1 and TRampA2 simultaneously at the time of the binning operation while suppressing a reduction in the conversion gain when the binning operation is not performed.

### Sixth Embodiment

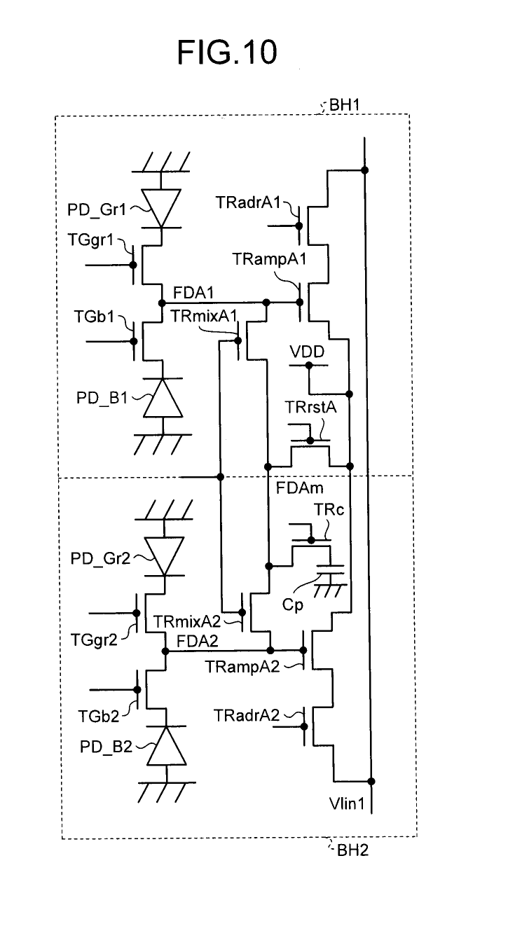

FIG. 10 is a circuit diagram illustrating an exemplary pixel configuration of 2×4 pixels in a 2-pixel 1-cell configuration of a solid-state imaging device according to a sixth embodiment. The example of FIG. 10 illustrates only a configuration for the vertical signal line Vlin1 of FIG. 6.

Referring to FIG. 10, in the solid-state imaging device, a coupling transistor TRc and a capacitor Cp are added to the configuration of FIG. 6. The capacitor Cp is connected to a connection point FDAm of the switching transistors TRmixA1 and TRmixA2 via the coupling transistor TRc.

Here, it is possible to add the capacitor Cp to the floating diffusions FDA1 and FDA2 by turning on the coupling transistor TRc when the switching transistors TRmixA1 and TRmixA2 are in the on state. Thus, it is possible to increase the saturation electron numbers of the voltage converting unit at the time of the binning operation, and it is possible to decrease the conversion gain. In this pixel configuration, for example, it is possible to obtain the high conversion gain as the saturation electron number of the floating diffusion FDA1 or FDA2 is ½ of the saturation electron number of the photo diode PD, and it is possible to improve the image quality as circuit noise at a subsequent stage is ½ at the time of shooting in a dark condition. At the time of shooting in a bright condition, as the switching transistors TRmixA1 and TRmixA2 are turned on, the conversion gain becomes about ½, and thus the saturation electron number of the photo diode PD can be converted into a voltage. At the time of the binning operation, since the signal charges are read from the two pixels of the photo diodes PD of the same color, the capacitor Cp is added by turning on the coupling transistor TRc, the conversion gain becomes ½, and thus the saturation electron number of the 2 pixels of the photo diodes is converted into a voltage.

### Seventh Embodiment

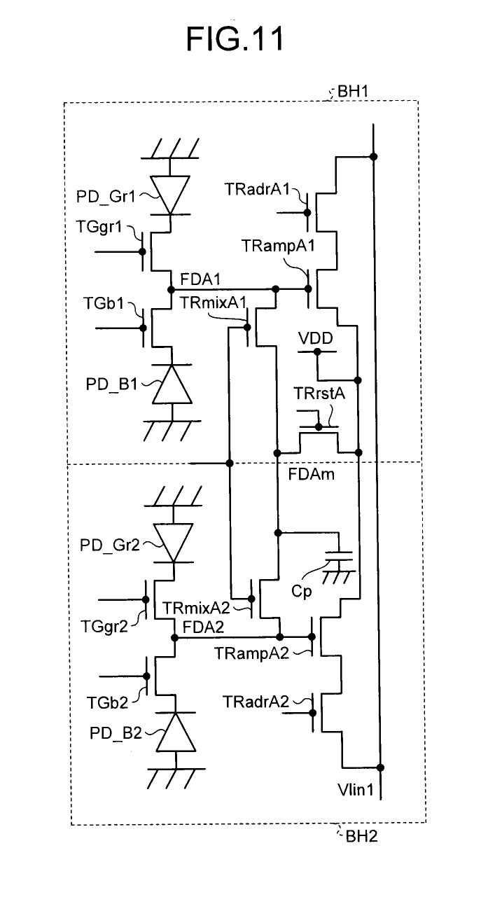

FIG. 11 is a circuit diagram illustrating an exemplary pixel configuration of 2×4 pixels in a 2-pixel 1-cell configuration of a solid-state imaging device according to a seventh embodiment.

Referring to FIG. 11, in the solid-state imaging device, the coupling transistor TRc is removed from the configuration of FIG. 10. The capacitor Cp is connected directly to a connection point of the switching transistors TRmixA1 and TRmixA2.

Here, it is possible to add the capacitor Cp to the floating diffusions FDA1 and FDA2 by turning on the switching transistors TRmixA1 and TRmixA2. Thus, it is possible to increase the saturation electron number of the voltage converting unit at the time of the binning operation, and it is possible to decrease the conversion gain.

### Eighth Embodiment

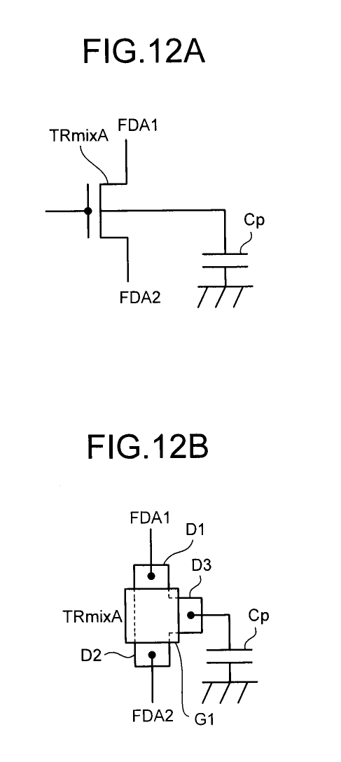

FIG. 12A is a circuit diagram illustrating an exemplary configuration of a switching transistor applied to a solid-state imaging device according to an eighth embodiment, and FIG. 12B is a plane view illustrating an exemplary layout configuration of the switching transistor of FIG. 12A. In the configurations of FIGS. 12A and 12B, a portion of the switching transistor TRmixA of FIG. 9 is selectively illustrated.

Referring to FIG. 12A, in the solid-state imaging device, a capacitor Cp is added to the channel area of the switching transistor TRmixA of FIG. 9. Further, as illustrated in FIG. 12B, the switching transistor TRmixA is provided with a gate electrode G1, and a channel area is formed below the gate electrode G1. Diffusion layers D1 and D2 are formed at both sides of the channel area. A diffusion layer D3 is formed at the side of the channel area, and the capacitor Cp is connected to the diffusion layer D3.

Here, it is possible to add the capacitor Cp to the floating diffusions FDA1 and FDA2 by turning on the switching transistor TRmixA. Thus, it is possible to increase the saturation electron number of the voltage converting unit at the time of the binning operation, and it is possible to decrease the conversion gain. As the diffusion layer D3 connected with the capacitor Cp is arranged at the side of the channel area, it is possible to suppress an increase in a layout area.

### Ninth Embodiment

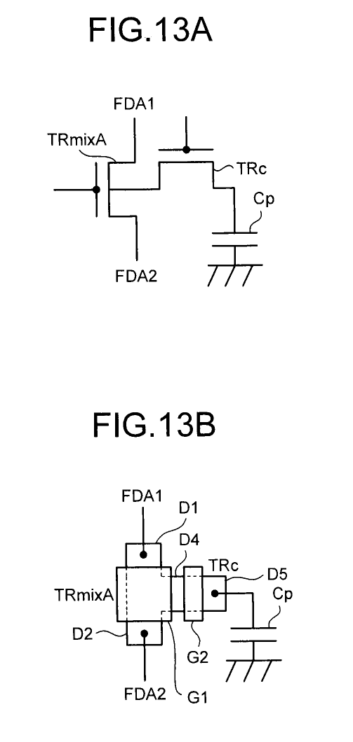

FIG. 13A is a circuit diagram illustrating an exemplary configuration of a switching transistor applied to a solid-state imaging device according to a ninth embodiment, and FIG. 13B is a plane view illustrating an exemplary layout configuration of the switching transistor of FIG. 13A.

Referring to FIG. 13A, in the solid-state imaging device, a capacitor Cp is added to the channel area of the switching transistor TRmixA of FIG. 12A via the coupling transistor TRc. Further, as illustrated in FIG. 13B, the coupling transistor TRc is provided with a gate electrode G2. Further, diffusion layers D4 and D5 are formed at both sides of the channel area below the gate electrode G2. Here, the diffusion layer D4 is arranged at the side of the channel area of the switching transistor TRmixA. The capacitor Cp is connected to the diffusion layer D5.

Here, it is possible to add the capacitor Cp to the floating diffusions FDA1 and FDA2 by turning on the coupling transistor TRc when the switching transistor TRmixA is in the on state. Thus, it is possible to increase the saturation electron number of the voltage converting unit at the time of the binning operation, and it is possible to further reduce the conversion gain. Further, as the diffusion layer D4 of the coupling transistor TRc is arranged at the side of the channel area of the switching transistor TRmixA, an interconnection for connecting the switching transistor TRmixA with the coupling transistor TRc is unnecessary, and it is possible to suppress an increase in a layout area.

### Tenth Embodiment

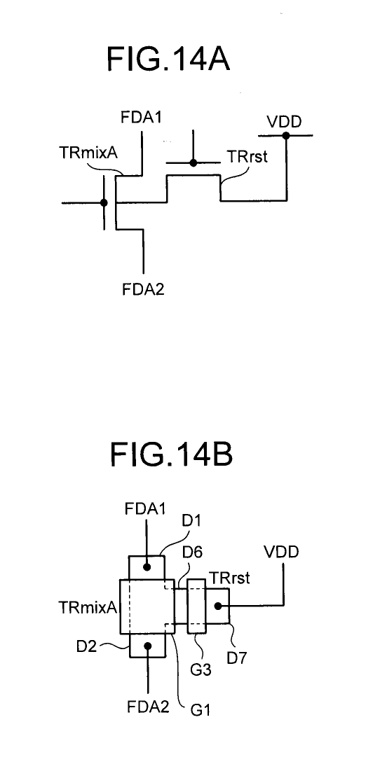

FIG. 14A is a circuit diagram illustrating an exemplary configuration of a switching transistor applied to a solid-state imaging device according to a tenth embodiment, and FIG. 14B is a plane view illustrating an exemplary layout configuration of the switching transistor of FIG. 14A. In the configuration of FIG. 14A and FIG. 14B, portions of the switching transistor TRmixA and the reset transistors TRrstA1 and TRrstA2 of FIG. 2 are selectively illustrated.

Referring to FIG. 14A, in the solid-state imaging device, the reset transistor TRrst is disposed instead of the reset transistors TRrstA1 and TRrstA2 of FIG. 2. Here, the channel area of the switching transistor TRmixA is connected to the power potential VDD via the reset transistor TRrst. Further, as illustrated in FIG. 14B, the reset transistor TRrst is provided with a gate electrode G3. Further, diffusion layers D6 and D7 are formed at both sides of the channel area below the gate electrode G3. Here, the diffusion layer D6 is arranged at the side of the channel area of the switching transistor TRmixA. The power potential VDD is connected to the diffusion layer D7.

Here, it is possible to reset the floating diffusions FDA1 and FDA2 by turning on the reset transistor TRrst when the switching transistor TRmixA is in the on state. Further, as the diffusion layer D6 of the reset transistor TRrst is arranged at the side of the channel area of the switching transistor TRmixA, the reset transistor TRrst can be shared by the floating diffusions FDA1 and FDA2. Thus, it is unnecessary to dispose the reset transistors TRrstA1 and TRrstA2 of FIG. 2 for the floating diffusions FDA1 and FDA2, respectively, and thus it is possible to reduce the number of reset transistors.

### Eleventh Embodiment

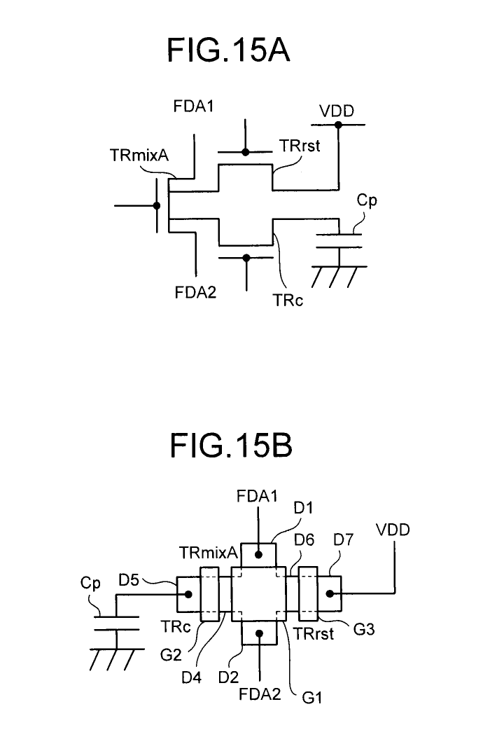

FIG. 15A is a circuit diagram illustrating an exemplary configuration of a switching transistor applied to a solid-state imaging device according to an eleventh embodiment, and FIG. 15B is a plane view illustrating an exemplary layout configuration of the switching transistor of FIG. 15A.

Referring to FIG. 15A, in the solid-state imaging device, a capacitor Cp is added to the channel area of the switching transistor TRmixA of FIG. 14A via a coupling transistor TRc. The coupling transistor TRc has a configuration similar to that of FIGS. 13A and 13B. Here, the diffusion layer D4 of the coupling transistor TRc and the diffusion layer D6 of the reset transistor TRrst may be arranged at the side of the channel area below the gate electrode G1 to face each other with the gate electrode G1 interposed therebetween.

Here, as the diffusion layer D4 of the coupling transistor TRc is arranged at the side of the channel area of the switching transistor TRmixA, an interconnection for connecting the switching transistor TRmixA with the coupling transistor TRc is unnecessary, and it is possible to suppress an increase in a layout area. Further, as the diffusion layer D6 of the reset transistor TRrst is arranged at the side of the channel area of the switching transistor TRmixA, it is unnecessary to dispose the reset transistors TRrstA1 and TRrstA2 of FIG. 2 for the floating diffusions FDA1 and FDA2, respectively, and thus it is possible to reduce the number of reset transistors.

### Twelfth Embodiment

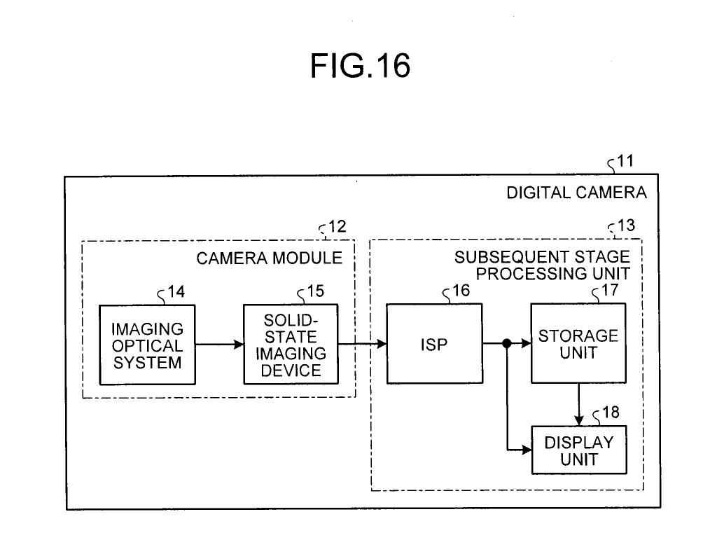

FIG. 16 is a block diagram illustrating a schematic configuration of a digital camera to which a solid-state imaging device is applied to a twelfth embodiment.

Referring to FIG. 16, a digital camera 11 includes a camera module 12 and a subsequent stage processing unit 13. The camera module 12 includes an imaging optical system 14 and a solid-state imaging device 15. The subsequent stage processing unit 13 includes an image signal processor (ISP) 16, a storage unit 17, and a display unit 18. At least a part of the ISP 16 may be integrated into one chip together with the solid-state imaging device 15. As the solid-state imaging device 15, for example, any configuration of FIG. 1 and FIGS. 6 to 11 may be used.

The imaging optical system 14 acquires light from a subject, and forms a subject image. The solid-state imaging device 15 images a subject image. The ISP 16 performs signal processing on an image signal obtained by the imaging by the solid-state imaging device 15. The storage unit 17 stores an image that has been subjected to the signal processing of the ISP 16. The storage unit 17 outputs the image signal to the display unit 18 according to the user's operation or the like. The display unit 18 displays an image according to the image signal input from the ISP 16 or the storage unit 17. The display unit 18 is, for example, a liquid crystal display. The camera module 12 can be applied to, for example, an electronic device such as a mobile terminal with a camera as well as the digital camera 11.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A solid-state imaging device, comprising:
a pixel array unit including pixels that accumulate charges obtained by photoelectric conversion and are arranged in a row direction and a column direction,
each of the pixels including
a photo diode that generates charges by photoelectric conversion,
a voltage converting unit that converts the charges generated by the photo diode into a voltage,
a read transistor that reads the charges generated by the photo diode out to the voltage converting unit,
an amplifying transistor that amplifies the voltage converted by the voltage converting unit, and
a switching transistor that is connected between the voltage converting units of same color pixels disposed in the column direction.

2. The solid-state imaging device according to claim 1,
wherein the two switching transistors are connected in series between the voltage converting units of neighboring same color pixels.

3. The solid-state imaging device according to claim 2, comprising a reset transistor that resets the voltage converting unit,
wherein the reset transistor is connected to a connection point at which the two switching transistors are connected in series.

4. The solid-state imaging device according to claim 3,
wherein one switching transistor is connected between the voltage converting units of the neighboring pixels, and
the reset transistor is connected to the switching transistor to perform resetting via the switching transistor.

5. The solid-state imaging device according to claim 1,
wherein one switching transistor is connected between the voltage converting units of the neighboring pixels, and
a capacitor is connected when the switching transistor is turned on.

6. The solid-state imaging device according to claim 3,
wherein the voltage converting unit includes
a first voltage converting unit that is shared by a first pixel and a second pixel that neighbor in the column direction, and
a second voltage converting unit that is shared by a third pixel and a fourth pixel that neighbor in the column direction, and
the switching transistor includes a switching transistor that connects the first voltage converting unit with the second voltage converting unit.

7. The solid-state imaging device according to claim 6,
wherein the reset transistor includes
a first reset transistor connected to a connection point of the first voltage converting unit and the switching transistor, and
a second reset transistor connected to a connection point of the second voltage converting unit and the switching transistor.

8. The solid-state imaging device according to claim 6,
wherein the switching transistor includes a first switching transistor in which two switching transistors are connected in series and a second switching transistor.

9. The solid-state imaging device according to claim 8,
wherein the reset transistor is connected to a connection point of the first switching transistor and the second switching transistor.

10. The solid-state imaging device according to claim 9 further comprising,
a capacitor connected to the connection point.

11. The solid-state imaging device according to claim 10, further comprising,
a coupling transistor connected to between the connection point and the capacitor.

12. The solid-state imaging device according to claim 3,
wherein the voltage converting unit includes
a first voltage converting unit that is shared by first, second, third and fourth pixels that are arranged in a form of a 2×2 matrix and
a second voltage converting unit that is shared by fifth, sixth, seventh and eighth pixels that are arranged in a form of a 2×2 matrix, and
the switching transistor includes a switching transistor that connects the first voltage converting unit with the second voltage converting unit.

13. The solid-state imaging device according to claim 12,
wherein the reset transistor includes
a first reset transistor that is connected to a connection point of the first voltage converting unit and the switching transistor, and
a second reset transistor that is connected to a connection point of the second voltage converting unit and the switching transistor.

14. The solid-state imaging device according to claim 12,
wherein the switching transistor includes a first switching transistor in which two switching transistors are connected in series and a second switching transistor that is connected to the first switching transistor in series.

15. The solid-state imaging device according to claim 14,
wherein the reset transistor is connected to a connection point of the first switching transistor and the second switching transistor.

16. The solid-state imaging device according to claim 13,
wherein the first, second, third and fourth pixels configure a first Bayer array, and the fifth, sixth, seventh and eighth pixels configure a second Bayer array.

17. The solid-state imaging device according to claim 16, further comprising:
a capacitor that is connected to the connection point; and
a coupling transistor that is connected between the connection point and the capacitor.

18. The solid-state imaging device according to claim 1, further comprising:
a column ADC circuit that calculates AD conversion values of pixel signals read from the pixels in units of columns based on a comparison result of the pixel signals and a reference voltage;
vertical signal lines that transfer the pixel signals read from the pixels to the column ADC circuit in units of columns; and
a load circuit that configures a source follower circuit with the pixels, and outputs the pixel signals from the pixels to the vertical signal lines in units of columns.

19. The solid-state imaging device according to claim 18,
wherein the load circuit configures the source follower circuit with a plurality of amplifying transistors for each column when the switching transistor is turned on.

20. The solid-state imaging device according to claim 18,
wherein when the switching transistor is turned on, the charges read out to the voltage converting unit are mixed, and thereafter, in a state in which the switching transistor is turned off, a signal is output to the vertical signal line via a plurality of amplifying transistors for each column.
